(19) United States
(12) Patent Application Publication
(10) Pub. No.: US 2008/0268549 A1
(43) Pub. Date: Oct. 30, 2008

(54) THIOFLAVIN T METHOD FOR DETECTION OF AMYLOID POLYPEPTIDE FIBRIL AGGREGATION

(76) Inventor: Thomas M. Nicotera, Buffalo, NY (US)

Correspondence Address: HODGSON RUSS LLP;THE GUARANTY BUILDING, 140 PEARL STREET, SUITE 100, BUFFALO, NY, 14202-4040, US

(21) Appl. No.: 12/104,980

(22) Filed: Apr. 17, 2008

Related U.S. Application Data
(60) Provisional application No. 60/923,865, filed on Apr. 17, 2007.

(51) Int. Cl. G01N 21/64

(52) U.S. Cl. 436/172

(57) ABSTRACT

The present invention provides a method for determining the stoichiometric ratio of the amyloid protein and the base which will result in a linear relationship between the amount of amyloid protein and the Thioflavin T fluorescence. Suitable stoichiometric ratios of the amyloid protein to base (such as 10 mM NaOH) of 1 μg:1 μl to 1 μg:1.25 μl can then be used in a Thioflavin T assay to identify potential agents which can inhibit or reduce amyloid protein fibril aggregation.

This application claims priority to U.S. application No. 60/923,865, filed on Apr. 17, 2007, the disclosure of which is incorporated herein by reference.

### FIELD OF THE INVENTION

The present invention relates generally to aggregation of amyloid polypeptides and more specifically provides a method for reliable measurement of amyloid fibril aggregation.

### BACKGROUND OF THE INVENTION

Alzheimer's disease (AD) is a debilitating neurodegenerative disorder affecting millions of elderly individuals throughout the world. One of the hallmarks of AD is the formation in the brain of extra-cellular protein deposits that consist predominantly of aggregates of the amyloid polypeptide β-amyloid (Aβ). Aβ is produced through the proteolytic processing of the β-amyloid precursor protein (Haass and Selkoe, 1993). Aβ is a peptide of 39-43 amino acids that is the main component of amyloid plaques in the brains of Alzheimer's disease patients. Amyloid deposits associated with AD and other neurodegenerative disorders result from the aberrant folding of cellular protein, such as Aβ into non-native conformations. These altered conformations result in the formation of fibrils characterized by their β-sheet structures (Kirschner et al., 1986) leading to the neuronal cell death (Selkoe, 1996).

Amyloid fibrils can be produced in vitro for studying Aβ-mediated cell toxicity and to devise strategies for inhibiting or reducing the Aβ-load. However, such approaches have been hampered by the lack of quantitative assays to monitor Aβ aggregation. For example, one method used to monitor protein fibril formation and aggregation is the Thioflavin T (ThT) method. ThT fluoresces only when bound to aggregated fibrils, producing a hypochromic shift in the bound dye (Levine, 1993). The reaction is initiated immediately upon mixing β-amyloid into an aqueous environment and is completed within one minute. Furthermore, ThT does not interfere with aggregation of Aβ fibrils. However, a significant drawback of this method is the lack of a quantitative relationship (Nilsson, 2004) and it yields results that are difficult to interpret (Levine 1999). This has hampered the identification of potential candidates which can inhibit Aβ fibril aggregation.

### SUMMARY OF THE INVENTION

The present invention is based on the unexpected observation that in the Thioflvin T assay for amyloid protein, at particular stoichiometries between the amyloid protein and the base used for solubilizing the amyloid protein, a linear relationship is observed between the fluorescence of Thioflavin T and the amount of the amyloid protein. Therefore, at these stoichiometries, the fluorescence of ThT can be used as a reliable indicator of the amyloid fibril aggregation.

Accordingly, in one embodiment, the present invention provides a method for determining the stoichiometric ratio of the amyloid protein and the base which will result in a linear relationship between the amount of amyloid protein and the fluorescence generated by the ThT assay. Once the optimal stoichiometric ratio has been identified, this ratio can then be used for screening of potential test agents for their ability to inhibit or reduce the amyloid fibril aggregates.

By using the above method, examples of suitable stoichiometric ratios of amyloid protein to base (such as 10 mM NaOH) were identified to be 1 μg:1 μl to 1 μg:1.25 μl. Therefore, in one embodiment, a stoichiometric ratio of the amyloid protein to base of 1 μg:1 μl to 1 μg:1.25 μl is used in a ThT assay to identify potential agents which can inhibit or reduce amyloid protein fibril aggregation.

### BRIEF DESCRIPTION OF THE DRAWINGS

FIG. 1 provides a graphical representation of ThT fluorescence from increasing quantities of β-amyloid peptide in 100 μl Tris buffer, pH 7.4. A non-linear increase in fluorescence is observed with increasing Aβ concentration. In addition, Aβ continues to aggregate with time.

FIG. 2 provides a graphical representation of ThT fluorescence from increasing quantities of β-amyloid in variable volumes of Tris buffer, pH 7.4. Decreasing the volume of NaOH used to dissolve Aβ results in an increase in ThT fluorescence at each concentration as well as a constant level of fluorescence with time.

FIG. 3 provides a graphical representation of the effect of dissolving 2.5 μg of Aβ in varying volumes of NaOH. Fluorescence was maximal when dissolving 2.5 μg of Aβ in 2.5-3.0 μl of NaOH, indicating that Aβ requires an optimal concentration for maximal fibril formation.

FIG. 4 provides a graphical representation of a ThT fluorescence standard curve for Aβ concentration. All concentrations of Aβ are dissolved in an optimized volume (ratio of 1 μg Aβ:1 μl 10 mM NaOH) and then transferred to 1.0 ml of Tris/ThT and the fluorescence measured. Fluorescent values are reported as the average in mV±S.D., n=3.

FIG. 5 provides a graphical representation of reversal of Aβ aggregation by colostrinin (CLN). A dose-dependent decrease in Aβ aggregation is observed with time, reaching a maximum of a 40% decrease at 2 days using 10 nM CLN. Fluorescent values are reported as the average in mV±S.D., n=2.

FIG. 6 provides a graphical representation of the effect of CLN and ThT on the secondary structure of Aβ as examined by the CD spectra. Treatment with CLN causes a shift from β-sheet to α-helix in Aβ conformation either at day or day 2, whereas there is no shift in untreated controls as shown in (panel A). ThT does not affect the Aβ conformational caused by CLN (panel B).

### DESCRIPTION OF THE INVENTION

The Thioflavin T assay is typically performed by providing a solution of the amyloid protein in a base and adding ThT solution in a buffer to the amyloid protein solution. Since ThT fluoresces only when bound to aggregated fibrils, a hypochromic shift in the bound dye, measured as fluorescence, is indicative of the presence of amyloid fibril aggregation.

The present invention is based on the unexpected observation that during the performance of the Thioflavin T assay, certain stoichiometries between the amount of amyloid polypeptide (such as Aβ) and the volume of a base used for solubilizing the polypeptide, results in a linear relationship between the ThT fluorescence and the amount of amyloid protein thereby providing a reliable measurement of aggregation of amyloid fibrils.

Thus, we have identified an anomaly caused in the Aβ solubilization steps in previous methods that results in a discontinuity of the fluorescence response. In the present method, by maintaining a constant stoichiometry of Aβ to base as described herein, the discontinuity in Aβ fluorescent response by ThT can be reduced if not eliminated. While not intending to be bound by any particular theory, it is considered that the protocol used for dissolving the Aβ may play an important role in the extent of β-sheet formation. This may be because the peptide strands need to be in close proximity in the soluble form in order to generate bonds between strands such that fibrils will form. Therefore, one of two conditions can be changed that will increase fiber formation: (1) increase in Aβ concentration or (2) a decrease in the volume in which Aβ is dissolved.

In the method of the present invention, the amyloid polypeptide, such as Aβ, is dissolved in a base (such as NaOH) at the selected stoichiometries, then placed in a buffer (such as Tris buffer) where aggregation takes place. It is believed that once aggregated, the ThT binding sites on Aβ become inaccessible to ThT, which results in reduced fluorescence. Thus, since it is considered that aggregation starts essentially immediately upon mixing of the Aβ into the buffer, it is preferred that the ThT is premixed in the buffer and therefore present during the aggregation process. Any standard buffer can be used. Suitable buffers include Tris, PBS, TBS and the like. A pH of from 7 to 9 is suitable. Thus, pH of from 7.2 to 7.6 and preferably 7.4 can be used.

The Aβ peptide is the most frequently found polypeptide in the amyloid plaques in brain. Aβ is a 39-43 amino acid peptide derived by proteolysis from a large protein known as Beta Amyloid Precursor Protein (“βAPP”). The structure and sequence of Aβ peptides of various lengths are well known in the art. Such peptides can also be made according to methods known in the art, or extracted from brain according to known methods. In addition, various forms of the peptides are commercially available (such as from Biosource), As used herein, the terms “Aβ” and “amyloid polypeptide” refer to beta-amyloid polypeptides or beta-amyloid precursor, unless otherwise specifically indicated. In particular, “Aβ” refers to a polypeptides that can be produced by proteolytic processing of the APP gene product, including polypeptides that are associated with amyloid pathologies, including but not limited to Aβ39, Aβ40, Aβ41, Aβ42, and Aβ43, wherein the numeric identifier indicates the number of amino acids in the peptide. These amino acids are identical to the amino acids in the KNAPP beginning at the N terminus. In one embodiment of the invention, inhibition of aggregation of the amyloid polypeptide Aβ40 by a test agent is measured.

The base used for solubilizing the Aβ can be any standard base. Such bases include, but are not limited to, sodium, potassium or ammonium base. Most common examples are NaOH and KOH. The strength (normality) of the base is not considered critical for obtaining a linear relationship between the ThT fluorescence and the amount of Aβ. In one embodiment, 10 mM NaOH was used, but all other molarities such as from 1 mM to 20 mM can also be used.

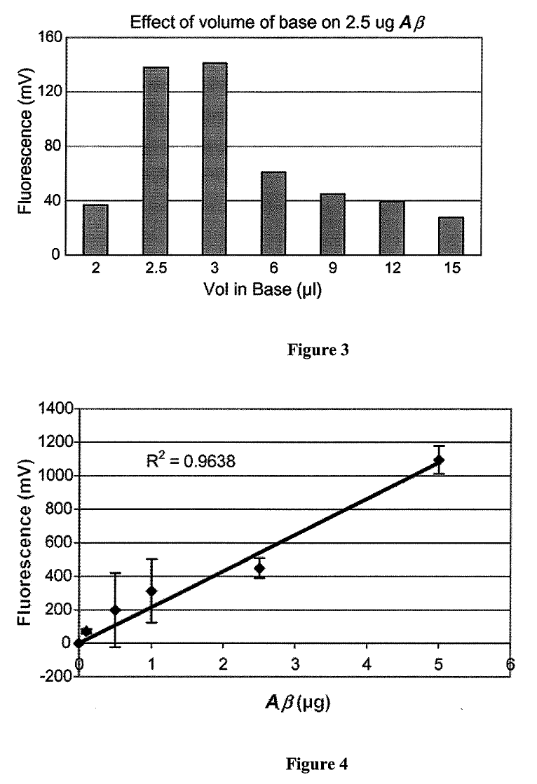

In the present invention, it was observed that the range of suitable stoichiometries of amyloid protein to base is between 1 μg:1 μl to 1 μg:1.25 μl. It is clear from FIG. 3 that maximum fluorescence was observed at 2.5 and 3.0 μl of the base for 2.5 μg of amyloid peptide. Using this range of stoichiometries, a linear relationship was observed between the ThT fluorescence and the amount of the amyloid peptide. Thus any of these two stoichiometrie and any stoichiometry between this range will be suitable for the present invention. Accordingly, included in this invention are stoichiometries of Aβ (μg) to base (μl) of 1:1; 1:1.1; 1:1.2 and 1:1.25. It was observed that if the stoichiometries were significantly outside of this range, the linear relationship was lost. For example, no linear relationship was observed at a ratio of Aβ (μg) to base (μl) of 1:0.8; 1:2.4; 1:3.6; 1:4.8 and 1:6. Therefore, the window in which a linear relationship is observed is well defined.

Those skilled in the art will recognize that with reference to FIG. 3, a Aβ (μg) to base (μl of 10 mM NaOH) ratio of 1:0.9 or 1:0.95 may work and this can be easily determined based on the disclosure provided in this application. Similarly, a Aβ (μg) to base (μl) ratio of 1:1.3 or 1:1.4 or 1:1.5; or 1:1.6; 1:1.7; 1:1.8; 1:1.9 or 1:2 may also work and this can easily be determined based on the disclosure in this application. The determination of suitability of these stoichiometries can be performed as follows. Various stoichiometries of the amyloid peptides to base can be selected and whether or not a linear relationship is observed between ThT fluorescence and the amount of the amyloid peptide can be determined. Thus, stoichiometries for Aβ (μg) to base (μl) ratio of 1:0.9; 1:1.3 or 1:1.4 or 1:1.5; or 1:1.6; 1:1.7; 1:1.8; 1:1.9 or 1:2 can be tested.

Having identified the stoichiometries between the amyloid protein and the base which result in a linear relationship between the amount of amyloid protein and the ThT fluorescence, this method can be used for screening of potential test agents for their ability to inhibit or reduce the amyloid fibril aggregates. For example, in this embodiment, a stoichiometric ratios of amyloid protein to base (1-20 mM NaOH) of 1 μg:1 μl to 1 μg:1.25 μl can be used. In one illustration of this embodiment, we used colostrinin (CLN) to validate this method for identifying potential test agents. CLN was selected as a model test agent because it has recently been reported that a proline-rich polypeptide derived from colostrum can reduce the aggregation of Aβ fibrils in vitro (Schuster et al., 2005).

The present method offers several advantages over previous techniques. For instance, most approaches recommend first solubilizing the amyloid polypeptide several times in organic solvents, then removing the solvent to the extent possible and finally placing the amyloid polypeptide in an aqueous buffer. This is a lengthy process and complete removal of organic solvent is generally not possible. In contrast, the present invention permits the use of comparatively low (microgram) concentrations of amyloid polypeptide, such as Aβ, to form aggregates and yield a high level of fluorescence. In contrast, several previous methods require 50 μg or higher levels of Aβ. This finding is significant, particularly in view of the high cost of Aβ. Further, it is demonstrated that, by following the modifications described herein to solubilize an amyloid polypeptide, a linear standard curve for fibril formation can be generated that permits the quantitative assessment of the effect of a test agent on fibril formation in a dose and time-dependent fashion. In addition to the linear dose-response curve, these modifications yield a considerably greater sensitivity as compared to other methods.

The present invention will be better understood by reference to the following examples, which are provided by way of illustration and not by way of limitation.

### EXAMPLE 1

This Example describes an illustrative method for performing the steps of the method of the invention.

(1) Prepare a stock ThT solution (1 mg/ml; 3.14 mM) in distilled, deionized water, aliquot into small samples and store long term at −20° C. in the dark. Thaw frozen samples only once and discard the remainder. Add 1.6 μl of ThT solution to 1.0 ml of 50 mM Tris buffer, pH 7.4 to yield a final 5.0 μM ThT solution.

(2) β-amyloid peptide (1-40) can be obtained from Biosource (Camarillo, Calif.), CLN from ReGen Therapeutics Plc (London, UK) and Thioflavin T from Sigma (St. Louis, Mo.). Prepare a stock solution of β-amyloid (by dissolving in 10 mM NaOH (0.5 mg/ml) and stored at −70° C. until used. Aβ in base is stable for at least 3 weeks frozen. Add 5.0 μl (2.5 μg) of β-amyloid stock solution to 1.0 ml of ThT/Tris buffer solution. It is preferable to avoid any contact with metal when preparing a amyloid solution since metal can oxidize the peptide.

(3) Measure the fluorescence intensity of 1.0 ml of Aβ/ThT/Tris solution using an excitation wavelength of 440 nm and an emission wavelength of 482 nm. A control solution of Aβ/Tris solution, without ThT can be used as a control. The fluorescence intensity above the control is used as a measure of fibril content. In addition, ThT/Tris solution should also be checked to ensure that it does not fluoresce.

(4) If the assay is intended to measure the change in Aβ aggregation and used to quantitate the effect of test agents, prepare a second sample containing the drug or agent as in step 2. Preincubate the samples for the appropriate length of time (usually days to weeks) required to yield a change in fluorescence intensity.

(5) A standard curve can be generated by first optimizing the fluorescence obtained at each concentration of Aβ used. This is accomplished by varying the volume of base used do dissolve each concentration of Aβ and the fluorescence was measured as demonstrated in FIG. 3. It is preferred to take multiple points in order to ensure statistical significance.

### EXAMPLE 2

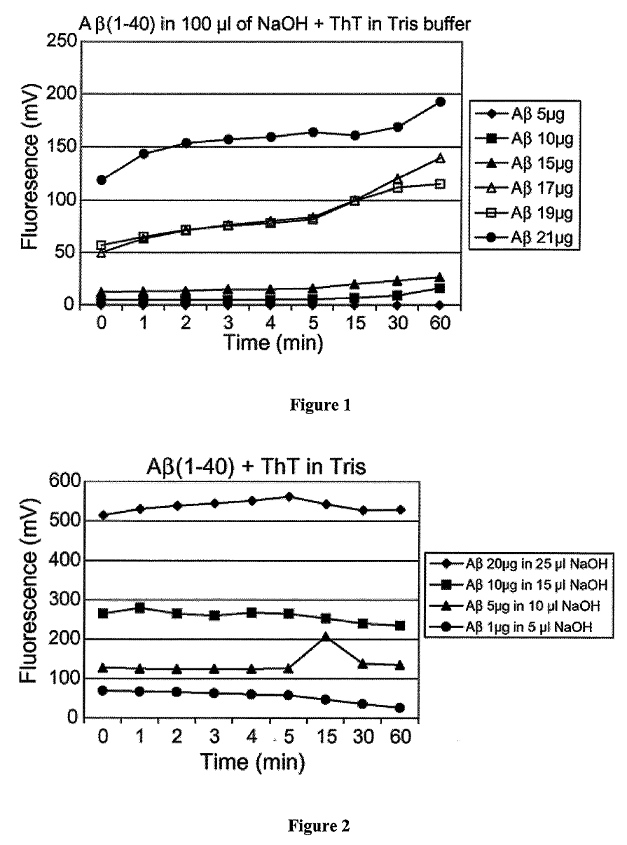

This example describes the relationship of ThT fluorescence to Aβ amount when the stoichiometries of Aβ to base were outside of the present invention. Increasing amounts of Aβ 40 was added to 100 μl of 10 mM NaOH, which was then transferred to 1.0 ml of Tris buffer at pH 7.4 and containing 5 μM ThT. As can be seen in FIG. 1, the fluorescence is not proportional to the amount of Aβ 40 peptide. Little fluorescence is observed at 5 and 10 μg of peptide and a significant increase in fluorescence takes place at 15 μg, but is not distinguishable from 17 μg of Aβ40. The stoichiometries for Aβ to base ranged from 1:20 to about 1:5.

### EXAMPLE 3

In order to test whether aggregation failed to take place due to the relatively large volume of base used to solubilize the smaller quantities of Aβ, a relatively constant ratio of peptide to the volume of base was maintained. As shown in FIG. 2, reducing the volume of base dramatically increases the resultant fluorescence at all concentration of peptide used. At the 5 μg/100 μl NaOH used in FIG. 1, fluorescence was negligible. Upon reducing the volume of base to 10 μl, the same 5 μg of peptide demonstrated a fluorescence of 300 mV, which is higher than that observed for 21 μg (˜120 mV) of Aβ dissolved in 100 μl of base in FIG. 1. Thus, by reducing the volume of base, an appreciable level of fluorescence was observed down to the 1 μg of Aβ. Furthermore, fluorescence remained constant after the first few seconds of oligomerization as opposed to FIG. 1, whereby the fluorescence intensity continued to increase over the 60 min using the larger volume of base.

### EXAMPLE 4

In order to further establish the significance of the volume used to solubilize Aβ, we titrated a constant amount of Aβ (2.5 μg) and dissolved it in an increasing volume of base. FIG. 3 indicates that dissolution of 2.5 μg of Aβ within the given range of volumes generates a bell-shaped fluorescent curve that increases approximately three-fold at its maxima as compared to its baseline fluorescence. This data indicates that each concentration of Aβ used requires optimization to volume of base.

### EXAMPLE 5

Standardization of the Thioflavin T method: The pattern obtained in FIG. 3 would suggest that, if each concentration of Aβ is empirically titrated within a narrow volume of base, a linear curve of λₘₐₓ values would be the result. It can be seen in FIG. 4 that we have obtained a linear response between Thioflavin T fluorescence with increasing concentration of Aβ dissolved in a ratio of 1 μg Aβ/1.25 μl 10 mM NaOH (R²>0.96).

### EXAMPLE 6

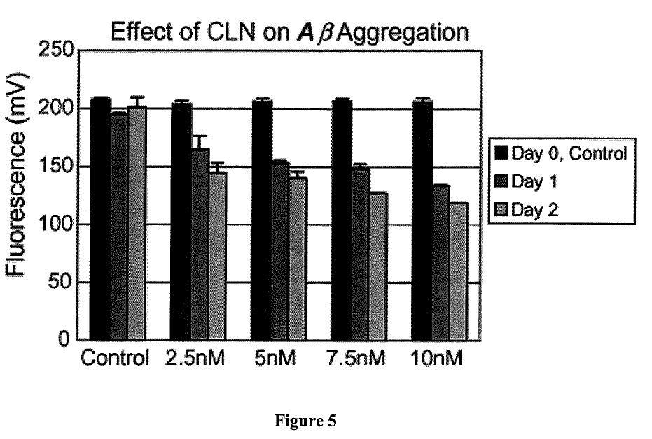

This example demonstrates the reliability of the present method for identifying blockers of Aβ aggregation. To demonstrate this, a known blocker of Aβ aggregation, Colostrinin (CLN) was used. Samples of Aβ in base were prepared as described in Example 1. ThT in Tris buffer was then added to the sample together with CLN at a concentration range of 2.5-10 nM and was preincubated for either 1 or 2 days and the fluorescence intensity measured following the above procedure. FIG. 5 shows a dose-dependent decrease in Aβ aggregation over a 2-day period with CLN treatment. After a 2-day treatment with 10 nM CLN, approximately 50% of the Aβ fibrils are dissolved. Thus, samples preincubated with CLN demonstrated protection at nanomolar concentrations that correlated with a decrease in fibril formation as demonstrated by electron microscopy (Schuster et al., 2005).

These results indicate that a standard curve for Aβ fluorescence can serve as a basis for measuring changes following treatment with various beta sheet-breaking drugs.

### EXAMPLE 7

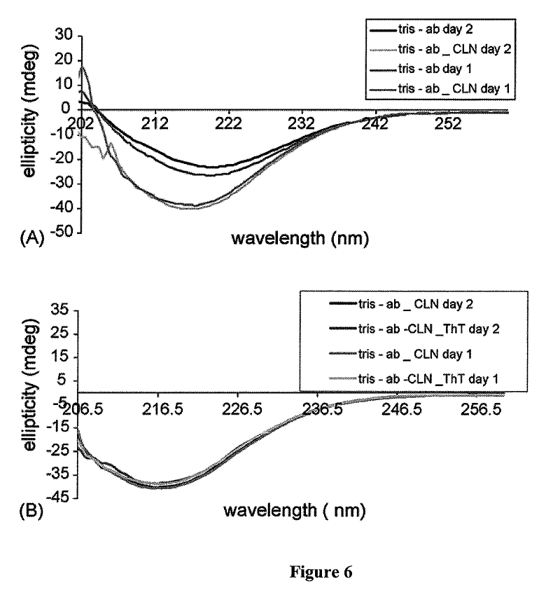

CD is routinely used to monitor changes in secondary structure (Wang et al., 2005). In order to verify that CLN does indeed cause a shift in secondary structure, a CD spectra of Aβ treated with CLN and control were taken at 24 and 48 h. For these experiments, a 10 μM solution of Aβ (1-40) (first solubilized in base as in previous examples) was prepared in 50 mM Tris buffer, pH 7.4, with and without 50 nM CLN and ThT. Circular dichroism (CD) spectra of the Aβ (1-40) peptide solutions were recorded using a Jasco J-715 CD spectropolarimeter at 25° C. using a bandwidth of 1.0 nm, a sensitivity of 0.5 nm and a recording speed of 50 nm/min. Multiple scans were run and a representative scans are shown in FIG. 6. The results were plotted as ellipticity (mdeg) versus wavelength (nm).

As shown in FIG. 6A, untreated samples of Aβ retain a greater β-sheet conformation, whereas the CLN-treated samples shifted to a random-coil/α-helical rich conformation after a 1- or 2-day treatment with an absorption minima at ˜218 nm. These experiments confirm that ThT fluorescence coincides with the β-sheet conformation of Aβ 40 and further reflects the changes in the level of β-sheet character following treatment with CLN. Furthermore, addition of ThT did not have an effect on the conformation of CLN treated samples (FIG. 6B).

### REFERENCES

1. Haass C, Selkoe D J. Cellular processing of β-amyloid precursor protein and the genesis of β-amyloid peptide. Cell 1993; 75:1039-42.
2. Kirschner D A, Abraham C, Selkoe D J. X-ray diffraction from intraneuronal paired helical filaments and extraneuronal amyloid fibers in Alzheimer disease indicates cross-beta conformation. Proc Natl Acad Sci USA 1986; 83:503-7.
3. Levine 3rd H. Thioflavin T interaction with Alzheimer's disease β-amyloid peptides: detection of amyloid aggregation in solution. Prot Sci 1993; 2: 404-10.
4. Levine 3rd H, Scholten J D. Screening for inhibitors of amyloid fibril formation. Methods Enzymol 1999; 309:467-76.
5. Nilsson M R. Techniques to study amyloid fibril formation in vitro. Methods 2004; 34:151-60.
6. Schuster D, Rajendran A, Hui S W, Nicotera T, Srikrishnan T, Kruzel M L. Protective effect of colostrinin on neuroblastoma cell survival is due to reduced aggregation of beta-amyloid. Neuropeptides 2005; 39:419-26.
7. Selkoe D J. Amyloid beta-protein and the genetics of Alzheimer's disease. J Biol Chem 1996; 271:18295-8.
8. Wang S S, Chen Y-T, Chou S-W. Inhibition of fibril formation of β-amyloid peptides via the amphiphilic surfactants. Biochim Biophys Acta 2005; 1741:307-13.

We claim:

1. A method for identifying an agent that can inhibit beta amyloid polypeptide (Aβ) aggregation comprising:
a) providing a solution comprising an amyloid polypeptide solubilized in a base such that the stoichiometric ratio of the polypeptide to the base is between and including 1 μg:1 μl to 1 μg:1.25 μl;
b) adding a buffer to a) in the presence or absence of the test agent;
c) adding and measuring fluorescence of Thioflavin T for the reactions obtained in b); and
d) comparing the fluorescence in the presence and absence of the test agent;
wherein a decrease in fluorescence of ThT in the presence of the test agent is an indication of the test agent being an inhibitor of amyloid polypeptide aggregation.

2. The method of claim 1, wherein the base has a molarity of from 1 mM to 20 mM.

3. The method of claim 1, wherein the buffer is Tris or phosphate buffered saline.

4. The method of claim 1, wherein the Aβ is selected from the group consisting of Aβ39, Aβ40, Aβ41, Aβ42, and Aβ43.

5. The method of claim 3, wherein the Aβ is Aβ40.

6. The method of claim 1, wherein the base is selected from the group consisting of sodium, potassium and ammonium base.

7. The method of claim 6, wherein the base is NaOH, KOH or NH₄OH.

8. The method of claim 7, wherein the base is 10 mM NaOH.

9. The method of claim 1, wherein the ThT is dissolved in Tris buffer at a pH of between 7 and 9.

10. The method of claim 9, wherein the ThT is dissolved in Tris buffer at a pH of 7.4.

11. The method of claim 1, wherein a period of time of from 1 to 7 days elapses between steps b) and c).

12. The method of claim 1, wherein steps b) and c) are performed simultaneously.

13. A method for identifying an agent that can inhibit amyloid polypeptide fibril aggregation comprising:
a) identifying a stoichiometric ratio of amyloid polypeptide to a base which results in a linear relationship between the amount of amyloid polypeptide and fluorescence generated upon reacting the polypeptide with Thioflavin T (ThT) in a buffer;
b) adding ThT in the buffer to the amyloid protein solution in the base at the stoichiometric ratio identified in a) in the presence and absence of the test agent;
c) measuring fluorescence of ThT for the reactions obtained in b); and
d) comparing the fluorescence in the presence and absence of the test agent;
wherein a decrease in fluorescence of ThT in the presence of the test agent is an indication of the test agent being an inhibitor of amyloid polypeptide aggregation.

14. The method of claim 13, wherein the base has a molarity of from 1 mM to 20 mM.

15. The method of claim 13, wherein the Aβ is selected from the group consisting of Aβ39, Aβ40, Aβ41, Aβ42, and Aβ43.

16. The method of claim 1, wherein the base is selected from the group consisting of sodium, potassium and ammonium base.

17. The method of claim 13, wherein the base is 10 mM NaOH.

18. The method of claim 17, wherein the ThT is dissolved in Tris buffer at a pH of between 7 and 9.

19. The method of claim 18, wherein the Tris buffer has a pH of 7.4.
